(19) United States
(12) Patent Application Publication
(10) Pub. No.: US 2020/0366852 A1
(43) Pub. Date: Nov. 19, 2020

(54) DISPLAY CONTROL APPARATUS AND CONTROL METHOD THEREOF

(71) Applicant: CANON KABUSHIKI KAISHA, Tokyo (JP)

(72) Inventors: Shogo Ueno, Yokohama-shi (JP); Tetsuya Hada, Mitaka-shi (JP)

(21) Appl. No.: 16/871,425

(22) Filed: May 11, 2020

(30) Foreign Application Priority Data
May 16, 2019 (JP) 2019-093202
May 16, 2019 (JP) 2019-093203

(51) Int. Cl. H04N 5/232; G06T 11/00

(52) U.S. Cl. CPC H04N 5/232933; G06T 11/00

(57) ABSTRACT

The present disclosure is directed to a display control apparatus capable of reducing the possibility that predetermined information is not displayed despite the user intention. The display control apparatus includes a selection unit including an OSD display ON setting to display a video image with information superimposed thereon on a first display unit or OFF, an output unit, and a control unit configured to perform control so that in a case of the OSD display ON, the video image is displayed with predetermined superimposed information, whereas in a case of the OSD display OFF, if outputting the display to a second display unit is enabled, the video image is displayed with no predetermined superimposed information, whereas if outputting the display to the second display unit is disabled, either (1) the video image is displayed with the predetermined superimposed information or (2) an OSD item is displayed.

### BACKGROUND OF THE INVENTION

### Field of the Invention

The present disclosure relates to a display control apparatus and a control method thereof, in particular, a technique for displaying an item on a display unit.

### Description of the Related Art

There are apparatuses that can be set to display or not to display a predetermined item and information. Japanese Patent Application Laid-Open No. 2014-042109 discloses a technique by which a display destination to display an image with image capturing information superimposed thereon is selectable.

Some of recent apparatuses such as cameras and image editing apparatuses are capable of outputting a display to a plurality of display destinations. With the method discussed in Japanese Patent Application Laid-Open No. 2014-042109, if a display destination on which a user intends to display an image with image capturing information superimposed thereon is not connected, the capturing information is not superimposed and displayed on the image. Thus, the user may not be able to view the image capturing information despite the user intention.

### SUMMARY OF THE INVENTION

The present disclosure is directed to a display control apparatus capable of reducing the possibility that predetermined information is not displayed despite the user intention.

According to an aspect of the present disclosure, a display control apparatus includes a selection unit including an on-screen display (OSD) display ON setting to display a video image with information superimposed on the video image on a first display unit or an OSD display OFF setting to display the video image without the information superimposed on the video image on the first display unit, an output unit configured to output a display to the first display unit and a second display unit different from the first display unit, and a control unit configured to perform control so that in a case where the OSD display ON setting is selected, the video image is displayed with predetermined information superimposed on the video image on the first display unit, whereas in a case where the OSD display OFF setting is selected, if outputting the display to the second display unit is enabled, the video image is displayed with no predetermined information superimposed on the video image on the first display unit, whereas if outputting the display to the second display unit is disabled, the video image is displayed with the predetermined information superimposed on the video image on the first display unit, in order to achieve the above-described object.

According to another aspect of the present disclosure, a display control apparatus includes a selection unit including an on-screen display (OSD) display ON setting to display a video image with information superimposed on the video image on a first display unit or an OSD display OFF setting to display the video image without the information superimposed on the video image on the first display unit, an output unit configured to output a display to the first display unit and a second display unit different from the first display unit, and a control unit configured to perform control so that in a case where the OSD display ON setting is selected, the video image is displayed with predetermined information superimposed on the video image on the first display unit, whereas in a case where the OSD display OFF setting is selected, if outputting the display to the second display unit is enabled, the video image is displayed with no predetermined information superimposed on the video image on the first display unit, whereas if outputting the display to the second display unit is disabled, an OSD display-related item is displayed on the first display unit, in order to achieve the above-described object.

Further features of the present disclosure will become apparent from the following description of exemplary embodiments with reference to the attached drawings.

### BRIEF DESCRIPTION OF THE DRAWINGS

FIGS. 1A and 1B are external views illustrating a camera according to an exemplary embodiment of the present disclosure.

FIG. 2 is a block diagram illustrating the camera according to the exemplary embodiment of the present disclosure.

FIGS. 3A and 3B area flowchart illustrating video image output terminal display processing according to the exemplary embodiment of the present disclosure.

FIGS. 4A to 4F are diagrams illustrating an example of a display according to the exemplary embodiment of the present disclosure.

### DESCRIPTION OF THE EMBODIMENTS

Various exemplary embodiments of the present disclosure will be described below with reference to the drawings.

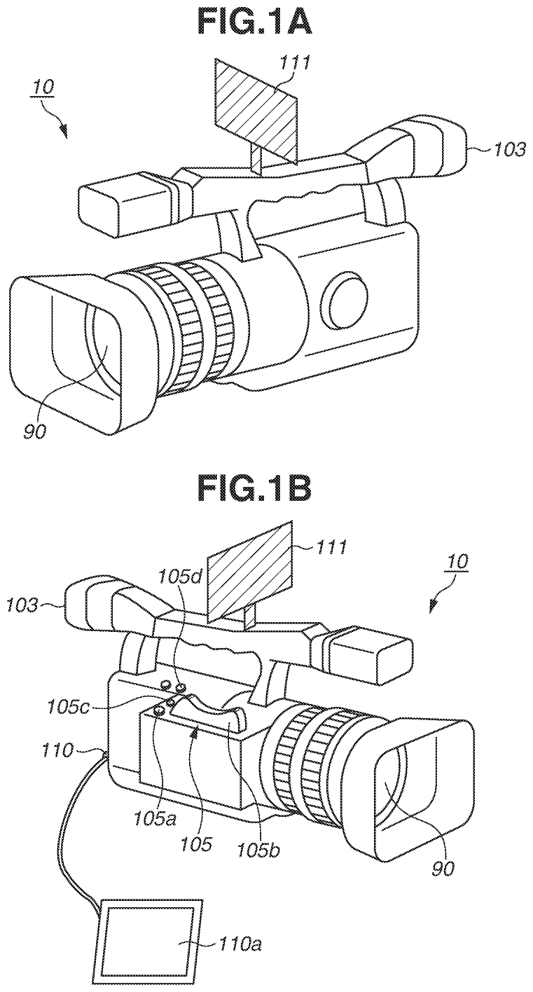

FIGS. 1A and 1B are views illustrating an example of an external configuration of a camera 10 as an example of a display control apparatus according to an exemplary embodiment of the present disclosure. FIG. 1A is a view illustrating the camera 10 viewed from one side, and FIG. 1B is a view illustrating the camera 10 viewed from another side.

The camera 10 includes an image capturing lens 90 at a front surface, a user operation unit 105 at a side surface, an electronic view finder (EVF) 103 at a rear surface, and a display unit 111 at a top surface. The EVF 103 and the display unit 111 are removable (detachable) from a main body of the camera 10. A video image output terminal 110 is a terminal for connecting an unremovable display unit to the camera 10 and is a High-Definition Multimedia Interface® (HDMI®) terminal or a serial digital interface (SDI) terminal. The user operation unit 105 is an operation member that includes a seesaw-type grip zoom 105b (zoom key), various switches for receiving various user operations, and buttons. The user operation unit 105 includes a controller wheel, which is a rotary operation member, a power switch for turning on or off, a menu button 105a for displaying a menu screen, and a moving image button 105c for inputting an instruction to start or stop image capturing. A mode selection switch 105d changes an operation mode of a system controller 106 to one of a still image recording mode, a moving image capturing mode, and a reproduction mode. With the mode selection switch 105d, the operation mode can be changed directly to one of the modes on the menu screen. Alternatively, after the screen is changed to the menu screen using the mode selection switch 105d, the operation mode may be changed to one of the modes on the menu screen using another operation member. Similarly, the moving image capturing mode may include a plurality of modes.

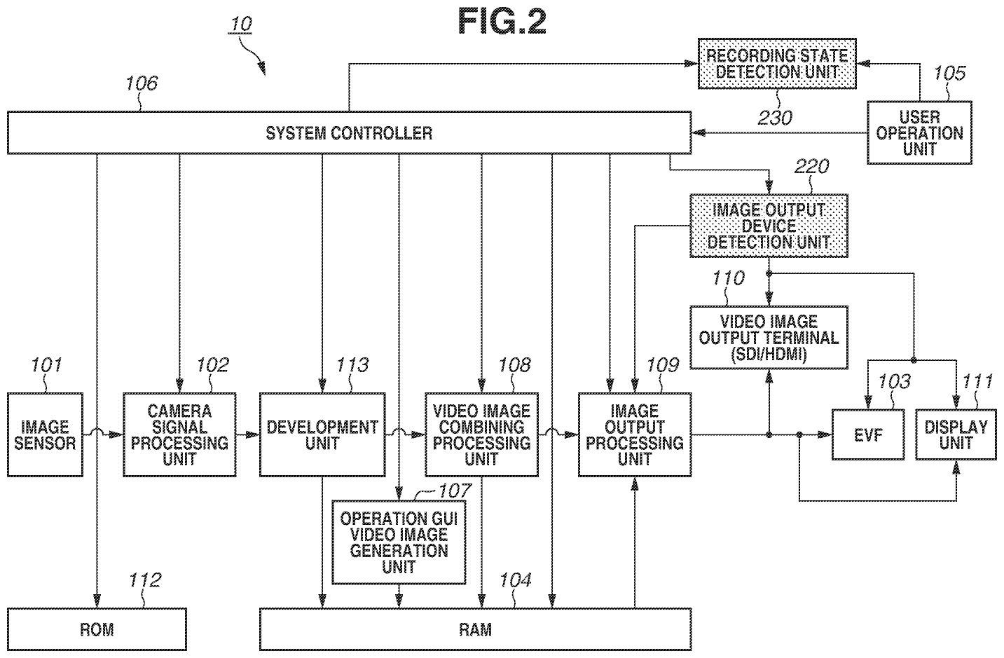

FIG. 2 is a block diagram illustrating an example of a configuration of the camera 10 as an example of the display control apparatus according to the present exemplary embodiment.

An image sensor 101 is an image sensor that includes a charge-coupled device (CCD) sensor or a complementary metal oxide semiconductor (CMOS) sensor and converts an optical image into an electric signal. A camera signal processing unit 102 receives a video image signal from the image sensor 101 and transmits the video image signal to a development unit 113. The development unit 113 corrects the video image signal and performs development, and the developed image is stored in a random access memory (RAM) 104.

The user operation unit 105 receives a user operation, and the system controller 106 performs processing based on the user operation. For example, if the press of the menu button 105a is detected, the menu screen is displayed on the display unit 111 or the EVF 103, and an item on the menu screen can be selected by operating a cross key (not illustrated) to designate a direction. In a case where a user instruction to display the menu screen or an item is issued, an operation graphical user interface video image generation unit 107 (operation GUI video image generation unit) generates necessary bitmap data. The generated data is stored in the RAM 104. In a case where a user instruction to display the menu screen or an item is issued, the stored video image signal and the stored bitmap data are combined together by a video image combining processing unit 108 to generate a GUI-superimposed video image, and the generated GUI-superimposed video image is stored in the RAM 104. In a case where an on-screen display (OSD) setting is set to “ON”, the video image with the menu screen superimposed thereon by the video image combining processing unit 108 is output and displayed.

The setting as to whether to superimpose a GUI display item on a video image to be output to the video image output terminal 110 and the setting as to whether to superimpose a GUI display item on a video image to be output to the display unit 111/the EVF 103 are separately may based on the user operation unit 105. The system controller 106 records the superimposition setting made to the video image output terminal 110 and the superimposition setting made to the display unit 111/the EVF 103 in the RAM 104 or, when necessary, in a read-only memory (ROM) 112. The video image output terminal 110 and the display unit 111/the EVF 103 output a video image based on the recorded settings so that in the case where the superimposition setting is made to superimpose the GUI display item, the video image with the GUI display item superimposed thereon is output, whereas in the case where the superimposition setting is made not to superimpose the GUI display item, the video image with no GUI display item superimposed thereon is output. The superimposition setting can be made for each output destination on the menu screen.

The video image output terminal 110 herein is a terminal connected to the camera 10 and is a general-purpose output terminal such as a SDI or HDMI terminal and is assumed to include one or more terminals. The video image output terminal 110 and a video image output unit 110a are connected to each other, and the video image output unit 110a displays a video image. Meanwhile, the display unit 111 and the EVF 103 can also be used to make a setting that relates to image capturing and a setting that relates to displaying by a user. For example, a user in charge of adjusting a sound volume in image capturing makes a sound volume setting based on a touch operation on the display unit 111, and a user in charge of an instruction to start or stop image capturing operates the user operation unit 105 while watching the EVF 103.

Further, each of processing of the camera signal processing unit 102, the development unit 113, the operation GUI video image generation unit 107, the video image combining processing unit 108, and an image output processing unit 109 is performed based on a program read from the ROM 112 by the system controller 106.

A recording state detection unit 230 checks whether a recording instruction is issued by a user via the user operation unit 105. A recording instruction status is stored in the RAM 104 by the system controller 106. If recording is being performed, the image output processing unit 109 outputs a video image with no GUI display item superimposed thereon to the video image output terminal 110 regardless of the superimposition setting made to the video image output terminal 110 and an operation status of a superimposition display timer.

An image output device detection unit 220 detects whether the display unit 111 and the EVF 103 (detachable video image display device) are connected to the camera 10.

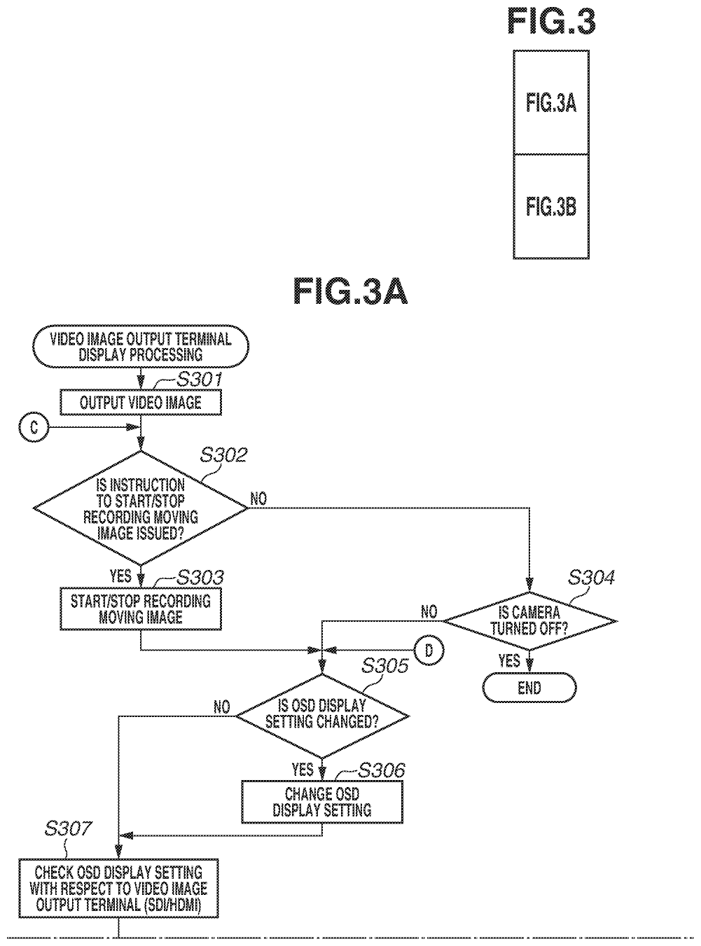

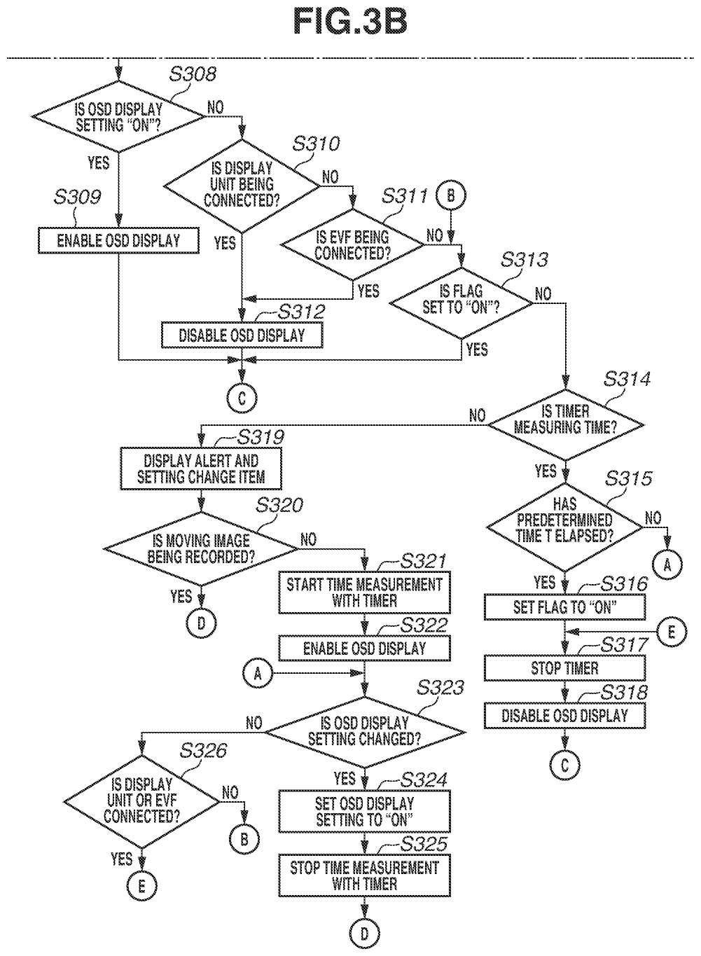

Next, video image output terminal display processing according to the present exemplary embodiment will be described below with reference to FIGS. 3A and 3B. The system controller 106 loads a program recorded in the ROM 112 (non-volatile memory) onto the RAM 104 (system memory) and executes the loaded program to thereby realize the processing. The processing is started if the camera 10 is turned on and outputting a display to the video image output terminal 110 is enabled.

In step S301, the system controller 106 performs display output of a video image acquired by the image sensor 101 to the video image output terminal 110. In the case of the reproduction mode, the system controller 106 acquires an image recorded in a recording medium, such as a secure digital (SD) card, and performs display output of the acquired image to the video image output terminal 110.

In step S302, the system controller 106 determines whether an instruction to start or stop recording a moving image is issued. In a case where the system controller 106 determines that an instruction to start or stop recording a moving image is issued (YES in step S302), the processing proceeds to step S303. Otherwise (NO in step S302), the processing proceeds to step S304.

In step S303, the system controller 106 starts or stops recording a moving image.

In step S304, the system controller 106 determines whether the camera 10 is to be turned off. The camera 10 is turned off if a power button (not illustrated) of the operation unit 105 is pressed by a user or a battery is used up. In a case where the system controller 106 determines that the camera 10 is to be turned off (YES in step S304), the processing illustrated in FIGS. 3A and 3B ends. Otherwise (NO in step S304), the processing proceeds to step S305.

In step S305, the system controller 106 determines whether an on-screen display (OSD) display setting is changed on the menu screen. In a case where the system controller 106 determines that the OSD display setting is changed (YES in step S305), the processing proceeds to step S306. Otherwise (NO in step S305), the processing proceeds to step S307.

In step S306, the system controller 106 changes the OSD display setting and records the changed setting into the ROM 112.

In step S307, the system controller 106 checks whether the current OSD display setting with respect to the video image output terminal 110 is “ON” (OSD display ON setting) or “OFF” (OSD display OFF setting).

In step S308, the system controller 106 determines whether the OSD display setting checked in step S307 is “ON”. In a case where the system controller 106 determines that the checked OSD display setting is “ON” (YES in step S308), the processing proceeds to step S309. Otherwise (NO in step S308), the processing proceeds to step S310.

In step S309, the system controller 106 enables the OSD display with respect to the video image output terminal 110. Specifically, the video image output in step S301 is displayed with the OSD superimposed thereon.

In step S310, the system controller 106 determines whether the display unit 111 is being connected to the camera 10. In a case where the system controller 106 determines that the display unit 111 is being connected to the camera 10 (YES in step S310), the processing proceeds to step S312. Otherwise (NO in step S310), the processing proceeds to step S311. The determination in step S310 is performed based on a result of the detection by the image output device detection unit 220.

In step S311, the system controller 106 determines whether the EVF 103 is being connected to the camera 10 (whether displaying on the EVF 103 is enabled). In a case where the system controller 106 determines that the EVF 103 is being connected to the camera 10 (YES in step S311), the processing proceeds to step S312. Otherwise (NO in step S311), the processing proceeds to step S313. In steps S310 and S311, even in a case where the display unit 111 and the EVF 103 are being connected to the camera 10, if outputting the video image or the OSD is disabled because, for example, it is impossible to transmit/receive an image signal, the system controller 106 determines that the display unit 111 and the EVF 103 are not being connected (NO in step S310 and S311).

In step S312, the system controller 106 disables the OSD display with respect to the video image output terminal 110.

In step S313, the system controller 106 determines whether a flag described below is set to “ON”. In a case where the system controller 106 determines that the flag is set to “ON” (YES in step S313), the processing proceeds to step S302. Otherwise (NO in step S313), the processing proceeds to step S314. The flag that is determined in step S313 indicates that the display output of the OSD is performed on the video image output terminal 110 for a predetermined length of time T because the video image output terminal 110 is the only OSD output destination. The OSD is displayed because the user may not recognize that the OSD is no longer visible, but after the OSD is displayed, the flag is set to “ON” to prevent an OSD display different from the settings made by the user.

In step S314, the system controller 106 determines whether a timer is measuring the time. The timer that is determined in step S314 is configured to measure the amount of time when the display output of the OSD is performed on the video image output terminal 110 for the predetermined length of time T while the OSD display setting by the user is “OFF”. In a case where the system controller 106 determines that the timer is measuring the time (YES in step S314), the processing proceeds to step S315. Otherwise (NO in step S314), the processing proceeds to step S319.

In step S315, the system controller 106 determines whether the predetermined length of time T has elapsed. The predetermined length of time T is, for example, 10 or 15 seconds. In a case where the system controller 106 determines that the predetermined length of time T has elapsed (YES in step S315), the processing proceeds to step S316. Otherwise (NO in step S315), the processing proceeds to step S323. In the present exemplary embodiment, even in the case where the OSD display setting by the user is “OFF”, the OSD is displayed in step S322 described blow to prevent the OSD from becoming invisible despite the user intention. At this time, if the predetermined length of time T has elapsed, the displayed OSD is disabled, and displaying is performed based on the OSD display setting made by the user, if the predetermined length of time T has elapsed, even if the user does not recognize that the OSD will become invisible, the user can change the setting during the processing, or in a case where the user does not mind the OSD becoming invisible, displaying is performed based on the user intension. In a state where displaying on the display unit 111 and the EVF 103 is disabled, if the setting not to display the OSD with respect to the video image output terminal 110 is made, the menu screen is also not superimposed and displayed on the video image. Thus, in a case where the OSD is no longer displayed despite the user intention, the set OSD may not be displayed promptly and operations may take time.

In step S316, the system controller 106 sets the flag to “ON” and records the flag in the RAM 104.

In step S317, the system controller 106 stops the timer.

In step S318, the system controller 106 disables the OSD display with respect to the video image output terminal 110.

In step S319, the system controller 106 displays an alert and a setting change item on a display unit of the video image output terminal 110. The alert indicates that the OSD display is not superimposed on the video image and becomes invisible.

In step S320, the system controller 106 determines whether the camera 10 is recording a moving image. In a case where the system controller 106 determines that the camera 10 is recording a moving image (YES in step S320), the processing proceeds to step S305. Otherwise (NO in step S320), the processing proceeds to step S321. If a moving image is being recorded, the video image is displayed with no OSD superimposed thereon in step S322. While a moving image is being recorded, even if the user does not intend that the OSD becomes invisible, a decrease in visibility of the video image being recorded is prevented.

In step S321, the system controller 106 starts the time measurement by the timer.

In step S322, the system controller 106 enables the OSD display and outputs the OSD to the video image output terminal 110 so that the OSD is superimposed and displayed.

In step S323, the system controller 106 determines whether an operation to change the OSD display setting is performed. The determination in step S323 is performed based on whether the setting change item displayed in step S319 is operated. In a case where the user recognizes that the OSD will become invisible due to the display in step S319, the user can change the OSD display setting to “ON”. In step S323, in a case where an operation to change the OSD display setting is performed, i.e., the OSD display setting is changed from “OFF” to “ON” (YES in step S323), the processing proceeds to step S324. Otherwise (NO in step S323), the processing proceeds to step S326.

In step S324, the system controller 106 makes the OSD display setting to “ON” and records the OSD display setting in the ROM 112.

In step S325, the system controller 106 stops the time measurement by the timer. As to the timer, the system controller 106 may measure the time, or a configuration of a system timer may be included so that the system timer measures the time.

In step S326, the system controller 106 determines whether the display unit 111 or the EVF 103 is connected to the camera 10. In a case where the system controller 106 determines that the display unit 111 or the EVF 103 is connected to the camera 10 (YES in step S326), the processing proceeds to step S317. Otherwise (NO in step S326), the processing proceeds to step S313. For example, in a case where the user wishes to disable the OSD display with respect to the video image output terminal 110 but wishes to prevent the OSD from being not superimposed and displayed on the video image, if another display unit is connected to the camera 10 during the processing, the OSD becomes visible. In the determination in each of steps S326, S310, and S311, whether another display unit is physically connected to the camera 10 does not have to be determined. For example, if there is a display unit that can output the video image and the OSD wirelessly or by wire, the system controller 106 can determine that the display unit is connected (YES in step S326, S310, S311).

In a case where the display unit 111 or the EVF 103 is connected when the power is turned on in step S301 but the display unit 111 or the EVF 103 is disconnected during the processing, the processing will be as follows. Specifically, in step S310 or S311, the system controller 106 determines that the display unit 111 or the EVF 103 is being connected (YES in step S310 or S311), and in step S312, the OSD display is disabled, but as a result that the display unit 111 or the EVF 103 is disconnected, in step S310 or S311, the system controller 106 determines that the display unit 111 or the EVF 103 is not connected (NO in step S310 or S311). Consequently, the processing proceeds to step S313, and in step S313, the system controller 106 determines that the flag is not set to “ON” (NO in step S313), and unless a moving image is being recorded, the OSD display is enabled. Further, in a case where the display unit 111 and the EVF 103 are both not connected and the OSD display setting is set to “OFF” when the power is turned on in step S301 but the display unit 111 or the EVF 103 is connected during the processing, the processing will be as follows. Specifically, even if the OSD is displayed in step S322, since the system controller 106 determines that the display unit 111 or the EVF 103 is being connected in step S310 or S311 (YES in step S310 or S311), the OSD display is disabled in step S312.

Even in a case where the determination in step S310 or S311 is not performed, if the system controller 106 determines that the OSD display setting is not “ON” in step S308 (NO in step S308), the display output of the OSD may be performed on the video image output terminal 110 for the predetermined length of time T.

Further, the determination of whether a moving image is being recorded in step S320 may be skipped and the OSD can be displayed in step S322 regardless of whether a moving image is being recorded.

The image output device detection unit 220 can check the connection status with respect to the display unit 111 or the EVF 103 either periodically or each time in step S310 or S311. In the case where the connection status is to be checked periodically, the period may be a frame rate period that is a video image update period or may be a video image update period of a panel or EVF.

Further, after the OSD display setting is set to “OFF” and the flag is set to “ON” and the OSD is no longer displayed on the display unit of the video image output terminal 110, if a moving image is not being recorded, the OSD can be displayed again for the predetermined length of time T at the press of the menu button 105a. Further, when the camera 10 is restarted, the flag is set to “OFF”, so that the OSD is displayed again.

Further, after the OSD is hidden, if the display unit 111 or the EVF 103 is not connected, an OSD-redisplay item can be superimposed and displayed on the video image so that the OSD may be re-displayed with ease.

The value of the predetermined length of time T may be a user-settable value or a fixed system value.

While the OSD is not displayed in the case where the system controller 106 determines that a moving image is being recorded in step S320 in the above description, the OSD may be output and displayed in step S322 if the moving image recording is stopped.

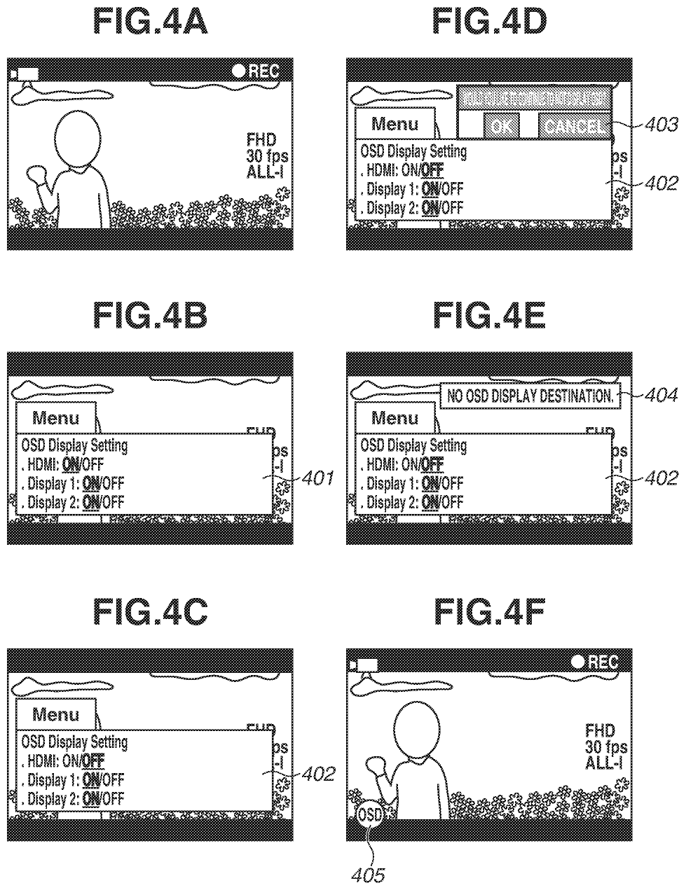

FIGS. 4A to 4F illustrate an example of a display on the display unit connected to the video image output terminal 110 according to the present exemplary embodiment, i.e., an example of a display output to the video image output terminal 110.

FIG. 4A illustrates an example of a video image that is output in step S301 in FIG. 3A. In the state illustrated in FIG. 4A, if the menu button 105a is pressed, a menu screen 401 as illustrated in FIG. 4B is output. On the menu screen 401, the OSD display setting for the HDMI terminal is set to “ON”, and the settings for other Displays 1 and 2 are also set to “ON”. The HDMI terminal corresponds to the video image output terminal 110, and Displays 1 and 2 respectively correspond to the display unit 111 and the EVF 103.

A menu screen 402 in FIG. 4C shows that the OSD display setting for the video image output terminal 110 is changed from “ON” to “OFF”. If the OSD display setting for the video image output terminal 110 is changed from “ON” to “OFF”, a setting change item 403 illustrated in FIG. 4D is output and displayed. On the setting change item 403, a text that prompts the user to select whether to hide the OSD is displayed together with items “OK” and “CANCEL” in a selectable state. The user selects the item “OK” in a case where the user determines that the OSD is to be hidden, or otherwise the user selects the item “CANCEL”. Specifically, in a case where the user does not intend that the video image is displayed with no information display superimposed thereon on every display destination, the user can select the item “CANCEL”. Further, in step S319, an alert 404 as illustrated in FIG. 4E is displayed. The setting change item 403 and the alert 404 can be displayed separately or together. Further, in a case where a moving image is being recorded, the displays illustrated in FIGS. 4D and 4E are not output, but an item 405 for re-displaying the OSD may be displayed as illustrated in FIG. 4F.

The various types of control that are described above as being performed by the system controller 106 may be performed by a single piece of hardware, or a plurality of pieces of hardware can share the processing to thereby control the entire apparatus.

Further, while the present disclosure has been described in detail with reference to the exemplary embodiment, the present disclosure is not limited to the specific exemplary embodiment, and various forms within the spirit of the present disclosure are also encompassed within the scope of the present disclosure. Furthermore, the above-described exemplary embodiment is a mere exemplary embodiment of the present disclosure, and exemplary embodiments can be combined as needed.

Further, while the case where the present disclosure is applied to the camera 10 is described as an example in the above-described exemplary embodiment, applications are not limited to the example, and the present disclosure is applicable to any control apparatus capable of controlling a display such as an OSD. Specifically, the present disclosure is applicable to a mobile phone terminal, a mobile image viewer, a printer apparatus with a finder, a digital photo frame, a music player, a game machine, and an electronic book reader.

### Other Exemplary Embodiments

The present disclosure is also realized by executing the below-described processing. Specifically, software (program) for realizing each function of the above-described exemplary embodiment is supplied to a system or an apparatus via a network or various recording mediums, and a computer (or CPU or micro-processing unit (MPU)) of the system or the apparatus reads a program code and executes the read program code. In this case, the program and a recording medium that stores the program are encompassed within the scope of the present disclosure.

Further, a case where a program of software for realizing each function of the above-described exemplary embodiment is supplied directly from a recording medium or via wired/wireless communication to a system or an apparatus that includes a computer capable of executing the program and the program is executed is also encompassed within the scope of the present disclosure.

Thus, the program code that is supplied to and installed into the computer so that the computer realizes the functional processing of the present disclosure realizes the present disclosure. Specifically, the computer program for realizing the functional processing of the present disclosure is also encompassed within the scope of the present disclosure. In this case, the program can be in any form that includes the function of the program, such as an object code, a program to be executed by an interpreter, or script data to be supplied to an operating system (OS).

Examples of a recording medium for supplying the program include a hard disk, a magnetic recording medium such as a magnetic tape, an optical/magneto-optical recording medium, and a non-volatile semiconductor memory.

Further, a possible method for supplying a program is a method in which a server on a computer network stores a computer program according to the present disclosure and a connected client computer downloads the computer program and performs programming.

The present disclosure reduces the possibility that predetermined information is not displayed despite the user intention.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2019-093202, filed May 16, 2019, and No. 2019-093203, filed May 16, 2019, which are hereby incorporated by reference herein in their entirety.

What is claimed is:

1. A display control apparatus comprising:
a selection unit including an on-screen display (OSD) display ON setting to display a video image with information superimposed on the video image on a first display unit or an OSD display OFF setting to display the video image without the information superimposed on the video image on the first display unit;
an output unit configured to output a display to the first display unit and a second display unit different from the first display unit; and
a control unit configured to perform control so that in a case where the OSD display ON setting is selected, the video image is displayed with predetermined information superimposed on the video image on the first display unit, whereas in a case where the OSD display OFF setting is selected, if outputting the display to the second display unit is enabled, the video image is displayed with no predetermined information superimposed on the video image on the first display unit, whereas if outputting the display to the second display unit is disabled, the video image is displayed with the predetermined information superimposed on the video image on the first display unit.

2. A display control apparatus comprising:
an output unit configured to output a display to a first display unit; and
a control unit configured to perform control so that in a case where at least one of a second display unit and a third display unit that are attachable to and detachable from an image capturing apparatus is connected to the image capturing apparatus and outputting the display is enabled, a video image is displayed with no predetermined information superimposed on the video image on the first display unit, whereas in a case where outputting the display to the second display unit and the third display unit is disabled, the video image is displayed with the predetermined information superimposed on the video image on the first display unit.

3. The display control apparatus according to claim 1, wherein the control unit performs control so that in a case where at least one of the second display unit and a third display unit that are attachable to and detachable from an image capturing apparatus is connected to the image capturing apparatus and outputting the display is enabled, a video image is displayed with no predetermined information superimposed on the video image on the first display unit, whereas in a case where outputting the display to the second display unit and the third display unit is disabled, the video image is displayed with the predetermined information superimposed on the video image on the first display unit.

4. The display control apparatus according to claim 1, wherein the control unit performs control so that in the case where the OSD display OFF setting is selected and outputting the display of information to the second display unit is disabled, the video image is displayed with the predetermined information superimposed on the video image on the first display unit for a predetermined length of time.

5. The display control apparatus according to claim 1, wherein the control unit performs control so that even in the case where the OSD display OFF setting is selected and outputting the display of information to the second display unit is disabled, if a moving image is being recorded, the video image is displayed with no predetermined information superimposed on the video image on the first display unit.

6. The display control apparatus according to claim 1, wherein if the OSD display OFF setting is selected and outputting the display to the second display unit is no longer enabled, the control unit performs control so that the video image is displayed with the predetermined information superimposed on the video image on the first display unit.

7. The display control apparatus according to claim 1, wherein the output unit outputs the display to the first display unit via a High-Definition Multimedia Interface® (HDMI®) terminal or a serial digital interface (SDI) terminal.

8. The display control apparatus according to claim 1, wherein the control unit performs control so that in the case where the OSD display OFF setting is selected, if outputting the display to the second display unit is disabled, an item configured to display the predetermined information is displayed on the first display unit.

9. The display control apparatus according to claim 8, wherein the control unit performs control so that the video image is displayed with the predetermined information or the item superimposed on the video image on the first display unit after a predetermined length of time passes after the OSD display OFF setting is selected and outputting the display to the second display unit is disabled.

10. The display control apparatus according to claim 1, wherein the control unit performs control so that even in the case where the OSD display OFF setting is selected and outputting the display to the second display unit is disabled, if a moving image being recorded is displayed on the first display unit, the video image is displayed with no predetermined information superimposed on the video image on the first display unit, and if the recording of the moving image is stopped, the video image is displayed with the predetermined information superimposed on the video image on the first display unit.

11. The display control apparatus according to claim 2, wherein the second display unit is an electronic view finder (EVF).

12. A method of controlling a display control apparatus, the method comprising:
selecting an OSD display ON setting to display a video image with information superimposed on the video image on a first display unit or an OSD display OFF setting to display the video image without the information superimposed on the video image on the first display unit;
outputting a display to the first display unit and a second display unit different from the first display unit; and
performing control so that in a case where the OSD display ON setting is selected, the video image is displayed with predetermined information superimposed on the video image on the first display unit, whereas in a case where the OSD display OFF setting is selected, if outputting the display to the second display unit is enabled, the video image is displayed with no predetermined information superimposed on the video image on the first display unit, whereas if outputting the display to the second display unit is disabled, the video image is displayed with the predetermined information superimposed on the video image on the first display unit.

13. A method of controlling a display control apparatus, the method comprising:
outputting a display to a first display unit; and
performing control so that in a case where at least one of a second display unit and a third display unit that are attachable to and detachable from an image capturing apparatus is connected to the image capturing apparatus and outputting the display is enabled, a video image is displayed with no predetermined information superimposed on the video image on the first display unit, whereas in a case where outputting the display to the second display unit and the third display unit is disabled, the video image is displayed with the predetermined information superimposed on the video image on the first display unit.

14. A computer-readable storage medium that stores a program for causing a computer to function as each unit of the display control apparatus according to claim 1.

15. A display control apparatus comprising:
a selection unit including an on-screen display (OSD) display ON setting to display a video image with information superimposed on the video image on a first display unit or an OSD display OFF setting to display the video image without the information superimposed on the video image on the first display unit;
an output unit configured to output a display to the first display unit and a second display unit different from the first display unit; and
a control unit configured to perform control so that in a case where the OSD display ON setting is selected, the video image is displayed with predetermined information superimposed on the video image on the first display unit, whereas in a case where the OSD display OFF setting is selected, if outputting the display to the second display unit is enabled, the video image is displayed with no predetermined information superimposed on the video image on the first display unit, whereas if outputting the display to the second display unit is disabled, an OSD display-related item is displayed on the first display unit.

16. The display control apparatus according to claim 15, wherein the control unit performs control so that in the case where the OSD display OFF setting is selected, if outputting the display of information to the second display unit is disabled, the predetermined information is displayed together with the item on the first display unit.

17. The display control apparatus according to claim 15, wherein the control unit performs control so that in the case where the OSD display OFF setting is selected, if outputting the display of the information to the second display unit is disabled, the item is displayed on the first display unit for a predetermined length of time after the OSD display OFF setting is selected.

18. The display control apparatus according to claim 17, wherein the control unit performs control so that the item and the predetermined information are not displayed on the first display unit after the item is displayed on the first display unit for the predetermined length of time.

19. The display control apparatus according to claim 15,
wherein the item is an item with which whether to change the OSD display OFF setting is selected, and
wherein the control unit performs control so that the predetermined information and the item are not displayed on the first display unit in a case where not changing the OSD display OFF setting is selected with the item.

20. The display control apparatus according to claim 15, wherein the item is an item that indicates that there is no display destination of the information superimposed on the video image.

21. The display control apparatus according to claim 15, wherein the first display unit is connected to the display control apparatus via a HDMI® terminal or a SDI terminal.

22. The display control apparatus according to claim 15, wherein the second display unit is removable from the display control apparatus.

23. The display control apparatus according to claim 15, wherein the control unit performs control so that in a case where the first display unit is only one display destination of the output unit, if the OSD display OFF setting is selected, the predetermined information is displayed together with the item on the first display unit.

24. The display control apparatus according to claim 15,
wherein displaying a video image of a moving image being recorded on the first display unit is enabled, and
wherein the control unit performs control so that in a case where the video image of the moving image is displayed on the first display unit, even if the OSD display OFF setting is selected, the item is not displayed on the first display unit.

25. A method of controlling a display control apparatus, the method comprising:
selecting an OSD display ON setting to display a video image with information superimposed on the video image on a first display unit or an OSD display OFF setting to display the video image without the information superimposed on the video image on the first display unit;
outputting a display to the first display unit and a second display unit different from the first display unit; and
performing control so that in a case where the OSD display ON setting is selected, the video image is displayed with predetermined information superimposed on the video image on the first display unit, whereas in a case where the OSD display OFF setting is selected, if outputting the display to the second display unit is enabled, the video image is displayed with no predetermined information superimposed on the video image on the first display unit, whereas if outputting the display to the second display unit is disabled, an OSD display-related item is displayed on the first display unit.

26. A computer-readable storage medium that stores a program for causing a computer to function as each unit of the display control apparatus according to claim 15.
